(19) United States
(12) Patent Application Publication
(10) Pub. No.: US 2020/0344757 A1
(43) Pub. Date: Oct. 29, 2020

(54) BASE STATION DEVICE, TERMINAL DEVICE, COMMUNICATION SYSTEM, AND TRANSMISSION METHOD

(71) Applicant: FUJITSU LIMITED, Kawasaki-shi (JP)

(72) Inventors: Hongyang Chen, Kawasaki (JP); Jianming Wu, Kawasaki (JP); Tsuyoshi Shimomura, Yokohama (JP)

(73) Assignee: FUJITSU LIMITED, Kawasaki-shi (JP)

(21) Appl. No.: 16/925,221

(22) Filed: Jul. 9, 2020

Related U.S. Application Data
(63) Continuation of application No. PCT/JP2018/000522, filed on Jan. 11, 2018.

(51) Int. Cl. H04W 72/04; H04L 1/00; H04W 88/06; H04W 88/10; H04W 16/14; H04W 72/12

(52) U.S. Cl. CPC H04W 72/0453; H04L 1/0026; H04W 88/06; H04W 72/0446; H04W 16/14; H04W 72/12; H04W 88/10

(57) ABSTRACT

A base station device is included in a communication system using a first frequency band that needs a license and a second frequency band that needs no license. The base station device includes: a processor that executes a process including judging whether the second frequency band is used by another communication system, and determining a transmission type indicating a time length of a transmission unit in the second frequency band based on a judgment result at the judging; and a transmitter that transmits notification information that notifies the transmission type determined at the determining.

### CROSS-REFERENCE TO RELATED APPLICATION

This application is a continuation of International Application No. PCT/JP2018/000522, filed on Jan. 11, 2018, the entire contents of which are incorporated herein by reference.

### FIELD

The embodiments discussed herein are related to a base station device, a terminal device, a communication system, and a transmission method.

### BACKGROUND

In the current networks, traffic of mobile terminals (smartphones and feature phones) occupies most of the resources of the networks. Furthermore, traffic used by the mobile terminals tends to continue to increase.

On the other hand, with the development of Internet of Things (IoT) services (for example, monitoring systems for transportation systems, smart meters, terminals, and the like), there is a need for supporting services having various requirements. Therefore, in the communication standard of the next generation (for example, 5G (fifth generation mobile communication)), there is a need for a technology of implementing a higher data rate, a larger capacity, and a lower delay, in addition to the standard technology (for example, Non-Patent Literatures 1 to 11) of 4G (fourth generation mobile communication). For the next generation communication standard, 3GPP working group (for example, TSG-RAN WG1, TSG-RAN WG2, and the like) is conducting technology studies (Non-Patent Literatures 12 to 39).

As described above, in order to support a wide variety of services, 5G is supposed to support many use cases classified into enhanced mobile broadband (eMBB), a massive machine-type communications (MTC), and ultra-reliable and low latency communication (URLLC). In order to support these use cases, for example, licensed-assisted access (LAA), which speeds up communication by bundling a frequency band that needs a license and a frequency band that needs no license, has been introduced from Rel. 13 of 3GPP specifications.

In the LAA, for example, data is transmitted and received in an unlicensed band (hereinafter, referred to as “U band”) requiring no license, which is used in, for example, a wireless local area network (LAN) and the like, by using, as an auxiliary, a licensed band (hereinafter, referred to as “L band”) requiring a license, which is used in a wireless communication system such as a mobile phone network.

Since the L band is a frequency band that needs a license, a licensed communication carrier and the like exclusively use a specific frequency band belonging to the L band, so that there is no interference with communication in other wireless communication systems. On the other hand, since the U band needs no license and is also used by other wireless communication systems such as the wireless LAN and the LAA operated by different carriers, when wireless communication is performed using the U band, interference may occur with communication in other wireless communication systems. In this regard, when a device performs wireless communication, listen before talk (LBT) is introduced, which confirms whether another device is performing wireless communication, such as carrier sense. In the LAA in the 4G system, a transmission device determines whether the U band is available by the LBT, and transmits data from the head of the next subframe when the U band is available.

In the 5G system also, the introduction of the LAA is considered. Therefore, the 3GPP working group are discussing the unlicensed frequency bands in the 5G system at the work item and study item phases (Non-Patent Literature 39).

Non-Patent Literature 1: 3GPP TS 36.211 V14.4.0 (2017 September)

Non-Patent Literature 2: 3GPP TS 36.212 V14.4.0 (2017 September)

Non-Patent Literature 3: 3GPP TS 36.213 V14.4.0 (2017 September)

Non-Patent Literature 4: 3GPP TS 36.300 V14.4.0 (2017 September)

Non-Patent Literature 5: 3GPP TS 36.321 V14.4.0 (2017 September)

Non-Patent Literature 6: 3GPP TS 36.322 V14.1.0 (2017 September)

Non-Patent Literature 7: 3GPP TS 36.323 V14.4.0 (2017 September)

Non-Patent Literature 8: 3GPP TS 36.331 V14.4.0 (2017 September)

Non-Patent Literature 9: 3GPP TS 36.413 V14.4.0 (2017 September)

Non-Patent Literature 10: 3GPP TS 36.423 V14.4.0 (2017 September)

Non-Patent Literature 11: 3GPP TS 36.425 V14.0.0 (2017 March)

Non-Patent Literature 12: 3GPP TS 37.340 V2.0.0 (2017 December)

Non-Patent Literature 13: 3GPP TS 38.201 V1.1.0 (2017 November)

Non-Patent Literature 14: 3GPP TS 38.202 V1.1.0 (2017 November)

Non-Patent Literature 15: 3GPP TS 38.211 V1.2.0 (2017 November)

Non-Patent Literature 16: 3GPP TS 38.212 V1.2.0 (2017 November)

Non-Patent Literature 17: 3GPP TS 38.213 V1.2.0 (2017 November)

Non-Patent Literature 18: 3GPP TS 38.214 V1.2.0 (2017 November)

Non-Patent Literature 19: 3GPP TS 38.215 V1.2.0 (2017 November)

Non-Patent Literature 20: 3GPP TS 38.300 V2.0.0 (2017 December)

Non-Patent Literature 21: 3GPP TS 38.321 V2.0.0 (2017 December)

Non-Patent Literature 22: 3GPP TS 38.322 V2.0.0 (2017 December)

Non-Patent Literature 23: 3GPP TS 38.323 V2.0.0 (2017 December)

Non-Patent Literature 24: 3GPP TS 38.331 V0.4.0 (2017 December)

Non-Patent Literature 25: 3GPP TS 38.401 V1.0.0 (2017 December)

Non-Patent Literature 26: 3GPP TS 38.410 V0.6.0 (2017 December)

Non-Patent Literature 27: 3GPP TS 38.413 V0.5.0 (2017 December)

Non-Patent Literature 28: 3GPP TS 38.420 V0.5.0 (2017 December)

Non-Patent Literature 29: 3GPP TS 38.423 V0.5.0 (2017 December)

Non-Patent Literature 30: 3GPP TS 38.470 V1.0.0 (2017 December)

Non-Patent Literature 31: 3GPP TS 38.473 V1.0.0 (2017 December)

Non-Patent Literature 32: 3GPP TS 38.801 V14.0.0 (2017 April)

Non-Patent Literature 33: 3GPP TS 38.802 V14.2.0 (2017 September)

Non-Patent Literature 34: 3GPP TS 38.803 V14.2.0 (2017 September)

Non-Patent Literature 35: 3GPP TS 38.804 V14.0.0 (2017 April)

Non-Patent Literature 36: 3GPP TS 38.900 V14.3.1 (2017 July)

Non-Patent Literature 37: 3GPP TS 38.912 V14.1.0 (2017 June)

Non-Patent Literature 38: 3GPP TS 38.913 V14.3.0 (2017 June)

Non-Patent Literature 39: “New SID on NR-based Access to Unlicensed Spectrum”, Qualcomm, 3GPP TSG RAN Meeting #75, RP-170828, Dubrovnik, Croatia, Mar. 6-9, 2017

However, when communication using the U band is performed, there is a problem in that the frequency utilization efficiency of the U band may be low. Specifically, for example, in the LAA of the 4G system described above, when another device is not performing wireless communication as a result of the LBT process, data is transmitted from the head of the next subframe. Consequently, from the completion of the LBT process to the head of the next subframe, the U band is not used by any device and a frequency band not used for data transmission/reception occurs. Therefore, when the LBT process is performed near the head of a subframe of 1 ms (millisecond), for example, the U band is not used for communication for about 1 ms until the next subframe, resulting in a decrease in frequency utilization efficiency.

### SUMMARY

According to an aspect of an embodiment, a base station device is included in a communication system using a first frequency band that needs a license and a second frequency band that needs no license. The base station device includes: a processor that executes a process including judging whether the second frequency band is used by another communication system, and determining a transmission type indicating a time length of a transmission unit in the second frequency band based on a judgment result at the judging; and a transmitter that transmits notification information that notifies the transmission type determined at the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a base station device according to a first embodiment;

FIG. 2 is a diagram illustrating specific examples of transmission types of a U band;

FIG. 3 is a block diagram illustrating a configuration of a terminal device according to the first embodiment;

FIG. 4 is a flowchart illustrating a transmission type switching process according to the first embodiment;

FIG. 5 is a diagram illustrating a specific example of downlink communication according to the first embodiment;

FIG. 6 is a diagram illustrating a specific example of downlink communication according to a second embodiment;

FIG. 7 is a diagram illustrating another specific example of the downlink communication according to the second embodiment;

FIG. 8 is a block diagram illustrating a configuration of a base station device according to a third embodiment; and

FIG. 9 is a diagram illustrating a specific example of downlink communication according to the third embodiment.

### DESCRIPTION OF EMBODIMENTS

Preferred embodiments of the present invention will be explained with reference to accompanying drawings. The problems and the embodiments in the present specification are examples and do not limit the scope of the claims of the present application. Particularly, even though description expressions are different, the technology of the present application can be applied and the scope of the claims is not limited as long as the described content is technically equivalent. Furthermore, the embodiments can be appropriately combined within the range in which processing content is not inconsistent.

Furthermore, terms used in the present specification and described technical content may appropriately be replaced with terms and technical content described in specifications and contributions as a standard for communication such as 3GPP. Such specifications include, for example, Non-Patent Literatures 1 to 38 described above.

### [a] First Embodiment

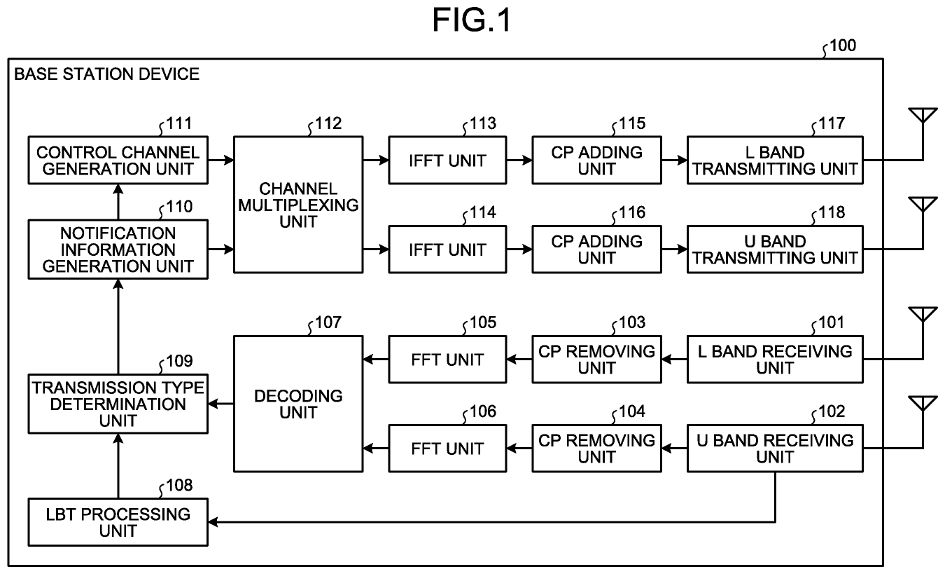

FIG. 1 is a diagram illustrating a configuration of a base station device 100 of a first embodiment. The base station device 100 illustrated in FIG. 1 includes an L band receiving unit 101, a U band receiving unit 102, cyclic prefix (CP) removing units 103 and 104, fast Fourier transform (FFT) units 105 and 106, and a decoding unit 107. These processing units are reception-side processing units of the base station device 100. Furthermore, the base station device 100 includes an LBT processing unit 108, a transmission type determination unit 109, a notification information generation unit 110, a control channel generation unit 111, a channel multiplexing unit 112, inverse fast Fourier transform (IFFT) units 113 and 114, CP adding units 115 and 116, an L band transmitting unit 117, and a U band transmitting unit 118. These processing units are transmission-side processing units of the base station device 100.

The L band receiving unit 101 receives an L band signal. That is, the L band receiving unit 101 receives a signal in a frequency band that needs a license.

The U band receiving unit 102 receives a U band signal. That is, the U band receiving unit 102 receives a signal in a frequency band that needs no license.

The CP removing units 103 and 104 remove CPs added between orthogonal frequency division multiplexing (OFDM) symbols from the received signals of the L band and the U band, respectively. That is, when wireless communication of an OFDM system is performed, since CPs are added that prevent inter-symbol interference between the OFDM symbols constituting a wireless signal, the CP removing units 103 and 104 remove the CPs. Although the present embodiment describes the case where the wireless communication of the OFDM system is performed, the present invention is also applicable to a case where wireless communication other than the OFDM system is performed. Consequently, when the wireless communication other than the OFDM system is performed, the CP removing units 103 and 104 can be omitted.

The FFT units 105 and 106 perform fast Fourier transform on the received signals of the L band and the U band, respectively, thereby acquiring a plurality of subcarrier signals having mutually orthogonal frequencies. That is, the FFT units 105 and 106 acquire the subcarrier signals by converting the received signals in a time domain into signals in a frequency domain. Since the FFT units 105 and 106 are also processing units that perform processing when the wireless communication of the OFDM system is performed, as with the aforementioned CP removing units 103 and 104, the FFT units 105 and 106 can be omitted when wireless communication other than the OFDM system is performed.

The decoding unit 107 decodes the received signals of the L band and the U band and acquires decoded data. The decoded data includes report information, which is information transmitted from a terminal device that is a communication partner of the base station device 100 and reports a result of an LBT process in the terminal device, and the like.

The LBT processing unit 108 detects reception energy in the frequency band of the U band when transmission data to be transmitted to the terminal device using the U band has been generated, and determines whether the U band is available. That is, when data to be transmitted using the U band has been generated, the LBT processing unit 108 performs an LBT process such as carrier sense. Specifically, when the reception energy in the U band is equal to or more than a predetermined threshold, the LBT processing unit 108 determines that the U band is being used by another device. Furthermore, when the reception energy in the U band is less than the predetermined threshold, the LBT processing unit 108 determines that the U band is available.

The transmission type determination unit 109 determines a transmission type of the U band based on a result of the past LBT process by the LBT processing unit 108, the past report information acquired by the decoding unit 107, a traffic amount of the U band, and the like. Specifically, the transmission type determination unit 109 selects one transmission type corresponding to the result of the LBT process, and the like, from a plurality of transmission types in which time lengths of transmission units are different.

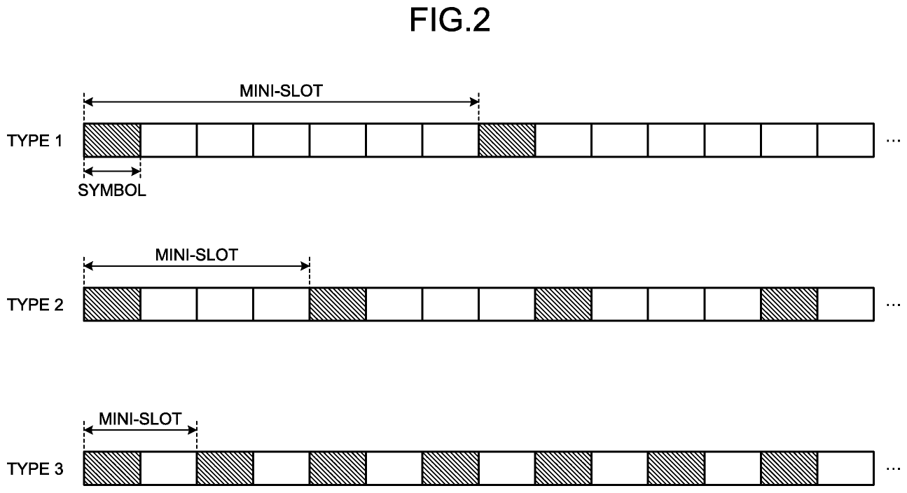

FIG. 2 is a diagram illustrating specific examples of transmission types of the U band. FIG. 2 illustrates three transmission types of types 1 to 3.

In type 1, a mini-slot (non-slot), which is a transmission unit, has a 7-symbol time length and data is transmitted in units of mini-slots. The hatched symbol at the head of the mini-slot in the drawing is, for example, a symbol including a control channel such as a physical downlink control channel (PDCCH). When downlink communication is performed according to type 1, the timing at which data transmission can be started is reached for each mini-slot having the 7-symbol length.

In type 2, the mini-slot, which is the transmission unit, has a 4-symbol time length and data is transmitted in units of mini-slots. As with type 1, also in type 2, the head symbol of the mini-slot includes the control channel. When downlink communication is performed according to type 2, the timing at which data transmission can be started is reached for each mini-slot having the 4-symbol length.

In type 3, the mini-slot, which is the transmission unit, has a 2-symbol time length and data is transmitted in units of mini-slots. As with type 1, also in type 3, the head symbol of the mini-slot includes the control channel. When downlink communication is performed according to type 3, the timing at which data transmission can be started is reached for each mini-slot having the 2-symbol length.

For example, when the U band is often available as the result of the past LBT process, the transmission type determination unit 109 selects a transmission type, in which the time length of the transmission unit is short, such as type 3, so that data transmission can be started immediately after the LBT process. On the other hand, for example, when the U band is not often available as the result of the past LBT process, the transmission type determination unit 109 selects a transmission type, in which the time length of the transmission unit is long, such as type 1, and reduces overhead due to the control channel. Furthermore, when the amount of data to be transmitted using the U band is large, the transmission type determination unit 109 may select a transmission type, in which the time length of the transmission unit is long, such as type 1.

The determination of the transmission type by the transmission type determination unit 109 may be performed at a predetermined cycle, for example, or may be performed when the tendency of the result of the LBT process has changed.

The notification information generation unit 110 generates notification information for notifying the terminal device of the transmission type determined by the transmission type determination unit 109. That is, the notification information generation unit 110 generates notification information that designates one transmission type determined by the transmission type determination unit 109 among the transmission types in which the time lengths of the transmission units are different. The notification information is generated as a signal in an upper layer, such as radio resource control (RRC) signaling unique to each terminal device, for example.

The control channel generation unit 111 generates signals of the control channels of the L band and the U band. Specifically, for the U band, the control channel generation unit 111 generates the signal of the control channel arranged in the head symbol of the mini-slot in accordance with the transmission type. The control channel includes allocation information and the like of data arranged in the mini-slot. That is, the control channel includes allocation information indicating a frequency domain of a symbol in the mini-slot to which data addressed to each terminal device is allocated.

The channel multiplexing unit 112 allocates the transmission data, the notification information, and the signal of the control channel to subcarriers in the respective frequency bands of the L band and the U band, and performs time multiplexing and frequency multiplexing. For the U band, when it is determined that the U band is available as the result of the LBT process by the LBT processing unit 108, the channel multiplexing unit 112 channel-multiplexes the transmission data and the signal of the control channel. Furthermore, the channel multiplexing unit 112 time-multiplexes the transmission data and the signal of the control channel in the mini-slot of the U band according to the transmission type determined by the transmission type determination unit 109.

The IFFT units 113 and 114 perform inverse fast Fourier transform on data for each subcarrier in the L band and the U band, respectively, thereby acquiring OFDM symbols in the time domain. That is, the IFFT units 113 and 114 convert data in the frequency domain allocated to each subcarrier into signals in the time domain, thereby acquiring the OFDM symbols. Since the IFFT units 113 and 114 are processing units that perform processing when the wireless communication of the OFDM system is performed, as with the aforementioned CP removing units 103 and 104 and FFT units 105 and 106, the IFFT units 113 and 114 can be omitted when wireless communication other than the OFDM system is performed.

The CP adding units 115 and 116 add CPs between the OFDM symbols of the L band and the U band, respectively, thereby generating transmission signals of the L band and the U band. Since the CP adding units 115 and 116 are also processing units that perform processing when the wireless communication of the OFDM system is performed, as with the aforementioned IFFT units 113 and 114, the CP adding units 115 and 116 can be omitted when wireless communication other than the OFDM system is performed.

The L band transmitting unit 117 transmits the transmission signal of the L band. That is, the L band transmitting unit 117 transmits a transmission signal in the frequency band that needs a license. The transmission signal includes, for example, the notification information generated by the notification information generation unit 110, and the like.

The U band transmitting unit 118 transmits the transmission signal of the U band. That is, the U band transmitting unit 118 transmits a transmission signal in the frequency band that needs no license.

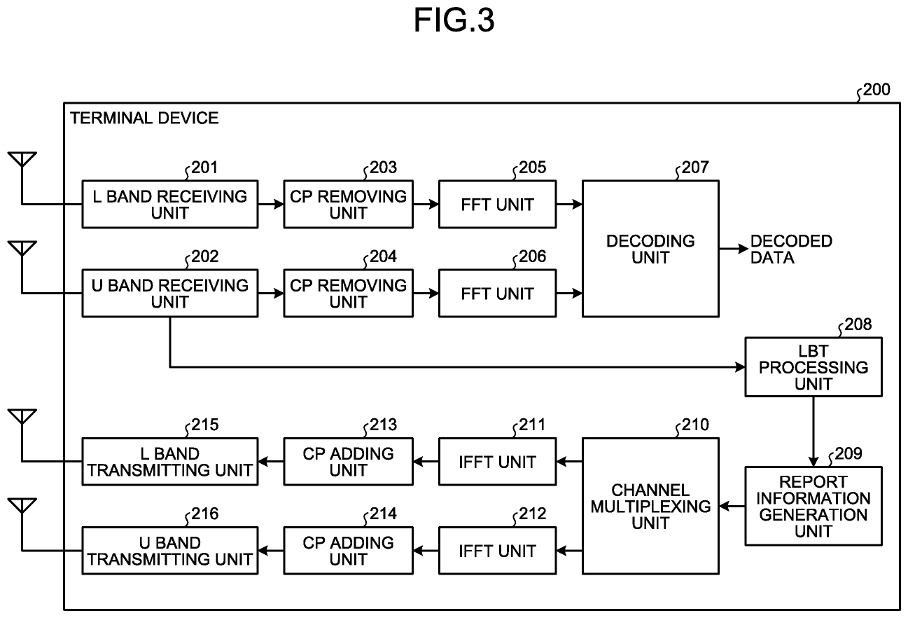

Next, the configuration of a terminal device that receives the signal transmitted from the base station device 100 will be described. FIG. 3 is a block diagram illustrating the configuration of a terminal device 200 according to the first embodiment. The terminal device 200 illustrated in FIG. 3 includes an L band receiving unit 201, a U band receiving unit 202, CP removing units 203 and 204, FFT units 205 and 206, and a decoding unit 207. These processing units are reception-side processing units of the terminal device 200. Furthermore, the terminal device 200 includes an LBT processing unit 208, a report information generation unit 209, a channel multiplexing unit 210, IFFT units 211 and 212, CP adding units 213 and 214, an L band transmitting unit 215, and a U band transmitting unit 216. These processing units are transmission-side processing units of the terminal device 200.

The L band receiving unit 201 receives the L band signal. That is, the L band receiving unit 201 receives a signal in the frequency band that needs a license. The received signal of the L band receiving unit 201 includes, for example, the notification information and the like transmitted from the base station device 100.

The U band receiving unit 202 receives the U band signal. That is, the U band receiving unit 202 receives a signal in the frequency band that needs no license.

The CP removing units 203 and 204 remove CPs added between the OFDM symbols from the received signals of the L band and the U band, respectively. Since the CP removing units 203 and 204 are also processing units that perform processing when the wireless communication of the OFDM system is performed, as with the aforementioned CP removing units 103 and 104, the CP removing units 203 and 204 can be omitted when wireless communication other than the OFDM system is performed.

The FFT units 205 and 206 perform fast Fourier transform on the received signals of the L band and the U band, respectively, thereby acquiring a plurality of subcarrier signals having mutually orthogonal frequencies. Since the FFT units 205 and 206 are also processing units that perform processing when the wireless communication of the OFDM system is performed, as with the aforementioned CP removing units 203 and 204, the FFT units 205 and 206 can be omitted when wireless communication other than the OFDM system is performed.

The decoding unit 207 decodes the subcarrier signals of the L band and the U band and acquires decoded data addressed to the terminal device 200. For the U band, the decoding unit 207 monitors the head symbol of the mini-slot according to the transmission type notified through the notification information such as RRC signaling. That is, the decoding unit 207 monitors the head symbol of each mini-slot having the 7-symbol length when the transmission type is, for example, the aforementioned type 1, and monitors the head symbol of each mini-slot having the 2-symbol length when the transmission type is, for example, the aforementioned type 3. Then, when the monitored symbol includes the signal of the control channel, the decoding unit 207 decodes the signal of the control channel, and specifies an allocation position of data addressed to the terminal device 200 in the mini-slot in which the signal of the control channel is arranged. Thereafter, the decoding unit 207 decodes the data at the specified allocation position and acquires the decoded data addressed to the terminal device 200 in the mini-slot.

The LBT processing unit 208 detects reception energy in the frequency band of the U band when transmission data to be transmitted to the base station device 100 using the U band has been generated, and determines whether the U band is available. That is, when data to be transmitted using the U band has been generated, the LBT processing unit 208 performs the LBT process such as carrier sense. Furthermore, even when the base station device 100 permits data transmission, the LBT processing unit 208 performs the LBT process again immediately before data transmission. Specifically, when the reception energy in the U band is equal to or more than a predetermined threshold, the LBT processing unit 208 determines that the U band is being used by another device. Furthermore, when the reception energy in the U band is less than the predetermined threshold, the LBT processing unit 208 determines that the U band is available.

The report information generation unit 209 generates report information for reporting the result of the LBT process by the LBT processing unit 208 to the base station device 100. That is, the report information generation unit 209 generates the report information indicating an availability state of the U band. The report information serves as an index indicating whether the U band is available or crowded.

The channel multiplexing unit 210 allocates the transmission data and the report information to subcarriers in the respective frequency bands of the L band and the U band, and performs time multiplexing and frequency multiplexing. For the U band, when it is determined that the U band is available as the result of the LBT process by the LBT processing unit 208, the channel multiplexing unit 210 channel-multiplexes the transmission data.

The IFFT units 211 and 212 perform inverse fast Fourier transform on data for each subcarrier in the L band and the U band, respectively, thereby acquiring OFDM symbols in the time domain. That is, the IFFT units 211 and 212 convert data in the frequency domain allocated to each subcarrier into signals in the time domain, thereby acquiring the OFDM symbols. Since the IFFT units 211 and 212 are processing units that perform processing when the wireless communication of the OFDM system is performed, the IFFT units 211 and 212 can be omitted when wireless communication other than the OFDM system is performed.

The CP adding units 213 and 214 add CPs between the OFDM symbols of the L band and the U band, respectively, thereby generating transmission signals of the L band and the U band. Since the CP adding units 213 and 214 are also processing units that perform processing when the wireless communication of the OFDM system is performed, as with the aforementioned IFFT units 211 and 212, the CP adding units 213 and 214 can be omitted when wireless communication other than the OFDM system is performed.

The L band transmitting unit 215 transmits the transmission signal of the L band. That is, the L band transmitting unit 215 transmits a transmission signal in the frequency band that needs a license.

The U band transmitting unit 216 transmits the transmission signal of the U band. That is, the U band transmitting unit 216 transmits a transmission signal in the frequency band that needs no license.

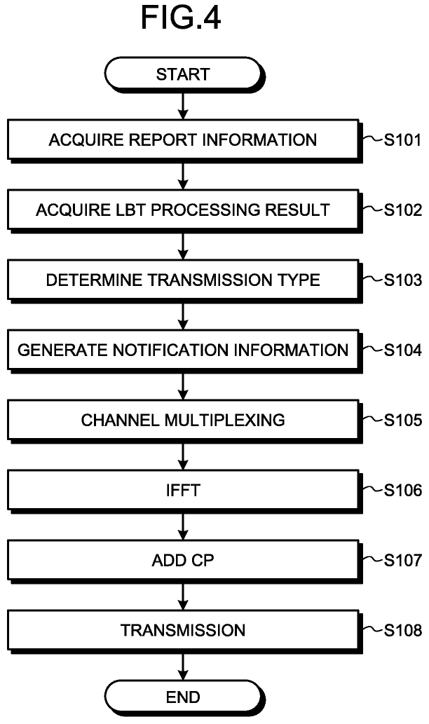

Next, a transmission type switching process of the U band according to the first embodiment will be described with reference to the flowchart illustrated in FIG. 4. The transmission type switching process to be described below is performed by the base station device 100.

When transmitting data using the U band, the base station device 100 and the terminal device 200 perform the LBT process and determines whether the U band is available. That is, the LBT processing unit 108 of the base station device 100 and the LBT processing unit 208 of the terminal device 200 perform the LBT process. Then, the result of the LBT process by the LBT processing unit 208 of the terminal device 200 is reported to the base station device 100 as report information. The report information may be transmitted from the terminal device 200 by using either the L band or the U band.

The report information is received by the L band receiving unit 101 or the U band receiving unit 102 of the base station device 100, is decoded by the decoding unit 107, and is acquired by the transmission type determination unit 109 (step S101). Furthermore, the transmission type determination unit 109 acquires the result of the LBT process from the LBT processing unit 108 of the base station device 100 (step S102). With this, the transmission type determination unit 109 can ascertain an availability state of the U band from the results of the LBT processes of the base station device 100 and the terminal device 200.

Therefore, based on the availability state of the U band and the amount of data to be transmitted using the U band, the transmission type determination unit 109 determines the transmission type of the U band (step S103). Specifically, the transmission type determination unit 109 selects one transmission type from the transmission types in which the time lengths of the transmission units are different. At this time, for example, when the U band is often crowded and not available, a transmission type, in which the time length of the transmission unit is long, is allowed to be selected, so that it may be possible to reduce a load on the terminal device 200 that monitors the presence or absence of a control channel for each transmission unit. Furthermore, for example, when the U band is often available, a transmission type, in which the time length of the transmission unit is short, is allowed to be selected and the timing at which data transmission can be started is allowed to frequently arrive, so that it may be possible to shorten the time until the start of data transmission after the LBT process. Moreover, for example, when the amount of data to be transmitted using the U band is large, a transmission type, in which the time length of the transmission unit is long, is allowed to be selected, so that it may be possible to increase the amount of data that can be transmitted for each transmission unit.

The determined transmission type is notified to the notification information generation unit 110, and the notification information generation unit 110 generates notification information for notifying the transmission type (step S104). The notification information is generated as a signal in an upper layer, such as RRC signaling unique to the terminal device 200, for example. Consequently, different transmission types can be individually notified to each terminal device 200. Furthermore, the transmission type is notified to the terminal device 200 through the notification information, so that it is possible to switch the transmission type from the current transmission type to different transmission types.

The notification information generated by the notification information generation unit 110 is channel-multiplexed with the transmission data, the signal of the control channel, and the like by the channel multiplexing unit 112 (step S105), and the multiplexed signal is subjected to inverse fast Fourier transform by the IFFT units 113 and 114 (step S106). Then, the CP adding units 115 and 116 add CPs to respective OFDM symbols obtained by the inverse fast Fourier transform (step S107), and the OFDM symbols with the CPs added are transmitted from the L band transmitting unit 117 and the U band transmitting unit 118 (step S108).

When the notification information is received by the terminal device 200, the terminal device 200 detects the transmission type indicated by the notification information. Then, the decoding unit 207 of the terminal device 200 monitors the presence or absence of the signal of the control channel for each timing of the head symbol of the transmission unit according to the transmission type. Therefore, the timing at which transmission in the U band can be started is allowed to arrive for each transmission unit, so that it is possible to shorten the time from the LBT process to the start of data transmission and to suppress a decrease in frequency utilization efficiency.

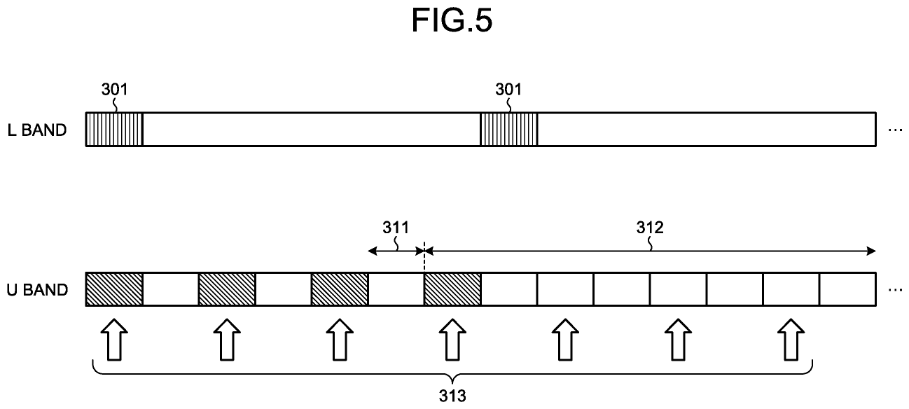

FIG. 5 is a diagram illustrating a specific example of downlink communication according to the first embodiment. As illustrated in the upper diagram of FIG. 5, in the L band, a control channel 301 of the L band is arranged at a predetermined cycle. The control channel 301 may include, for example, information on an uplink (UL) grant that permits uplink communication, and the like.

On the other hand, as illustrated in the lower diagram of FIG. 5, in the U band, a symbol capable of transmitting the control channel of the U band is arranged for each transmission unit designated by a transmission type. In FIG. 5, since the transmission unit designated by the transmission type is the 2-symbol length, the head symbol of each transmission unit indicated by the diagonal lines in the drawing is a symbol on which the control channel can be transmitted. Consequently, when the base station device 100 performs the LBT process in a section 311, for example, and determines that the U band is available, the base station device 100 can transmit the signal of the control channel by using the head symbol of the next transmission unit, and transmit data in a section 312. That is, the time from the end of the section 311, in which the LBT process is performed, to the start of the section 312, in which data is transmitted, is suppressed to the 2-symbol length at maximum, so that it is possible to shorten wasteful time for which the U band is not used for communication. As a consequence, it is possible to suppress a decrease in frequency utilization efficiency.

Since the base station device 100 transmits the signal of the control channel in the head symbol of the section 312, the terminal device 200 can be notified of resource allocation for transmission data by the control channel. Therefore, in the section 312, the signal of the control channel is arranged only in the head symbol, so that resources can be allocated to data addressed to the terminal device 200 to the maximum extent. However, when another terminal device, other than the terminal device 200, is notified of the transmission type in which the transmission unit has the 2-symbol length, the other terminal device continuously monitors the presence or absence of the control channel every two symbols. That is, the other terminal device monitors the presence or absence of the control channel addressed to itself at each timing 313 indicated by the arrows in the drawing.

As described above, according to the present embodiment, a base station device selects one transmission type from the transmission types in which the time lengths of the transmission units are different and notifies a terminal device of the transmission type in the U band. Then, the terminal device monitors the presence or absence of the control channel for each transmission unit according to the notified transmission type. Therefore, the timing at which data transmission can be started is designated by the transmission type, so that it is possible to shorten the time from the LBT process to the start of data transmission and to suppress a decrease in frequency utilization efficiency.

### [b] Second Embodiment

The feature of a second embodiment is that the monitoring cycle of the control channel by a terminal device is controlled by common control information.

Since the configurations of a base station device and a terminal device according to the second embodiment are the same as those in the first embodiment, a description thereof will be omitted. However, in the second embodiment, the notification information generation unit 110 of the base station device 100 generates, as signal common to terminal devices, notification information for notifying the terminal devices of the transmission type determined by the transmission type determination unit 109. That is, the notification information generation unit 110 generates the notification information as a signal in an upper layer, such as RRC signaling common to the terminal devices, for example. Consequently, the common transmission type is notified to the terminal devices communicating with the base station device 100, and each terminal device monitors the presence or absence of the control channel for the same symbol.

Furthermore, the control channel generation unit 111 of the base station device 100 arranges the common control information in the control channel of the U band. The common control information indicates a terminal device, which is a destination of data to be transmitted using the U band, and the number of transmission units in which data transmission to the terminal device is continued. That is, the common control information is information indicating a terminal device using the U band and time for which the U band is occupied by the terminal device.

In the second embodiment, since the transmission type is common to each terminal device, each terminal device monitors the presence or absence of the control channel at the same cycle according to the same transmission type. Furthermore, when communication using the U band is started for any terminal device, the common control information is included in a control channel at the head of a transmission unit in which the communication is started. Since the common control information indicates time for which the U band is occupied, another terminal device, other than a terminal device serving as a destination of data to be transmitted through the U band, can recognize time, for which the monitoring of the presence or absence of the control channel is not needed, from the common control information. That is, since time for which any terminal device occupies the U band is time for which data addressed to the other terminal device is not transmitted using the U band, this time is time for which the other terminal device does not need to monitor the presence or absence of the control channel. Therefore, based on the common control information, the other terminal device omits the monitoring of the presence or absence of the control channel while the U band is occupied. With this, it is possible to reduce a processing load of monitoring the control channel by the terminal devices. In other words, it is possible to reduce overhead due to the control channel.

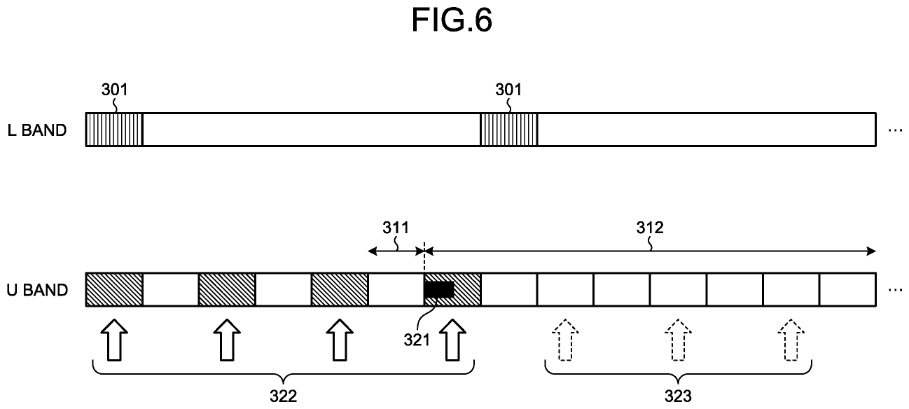

FIG. 6 is a diagram illustrating a specific example of downlink communication according to the second embodiment. In FIG. 6, the same parts as those in FIG. 5 are denoted by the same reference numerals. As illustrated in the upper diagram of FIG. 6, in the L band, a control channel 301 of the L band is arranged at a predetermined cycle. The control channel 301 may include, for example, information on a UL grant that permits uplink communication, and the like.

On the other hand, as illustrated in the lower diagram of FIG. 6, in the U band, a symbol capable of transmitting the control channel of the U band is arranged for each transmission unit designated by a transmission type. In FIG. 6, since the transmission unit designated by the transmission type is the 2-symbol length, the head symbol of each transmission unit indicated by the diagonal lines in the drawing is a symbol on which the control channel can be transmitted. Consequently, when the base station device 100 performs the LBT process in a section 311, for example, and determines that the U band is available, the base station device 100 can transmit the signal of the control channel by using the head symbol of the next transmission unit, and transmit data in a section 312. That is, the time from the end of the section 311, in which the LBT process is performed, to the start of the section 312, in which data is transmitted, is suppressed to the 2-symbol length at maximum, so that it is possible to shorten wasteful time for which the U band is not used for communication. As a consequence, it is possible to suppress a decrease in frequency utilization efficiency.

Furthermore, when the base station device 100 transmits data in the section 312, the control channel of a head symbol includes common control information 321. The common control information 321 is decoded by another terminal device other than a terminal device serving as a destination of the data in the section 312. Furthermore, since the common control information 321 indicates a terminal device using the U band in the section 312 and time for which the U band is occupied by the terminal device, the other terminal device can recognize time for which the monitoring of the control channel is not needed.

Therefore, the other terminal device monitors the presence or absence of the control channel at timing 322 every two symbols until the section 312 is started, but in the section 312, the monitoring of the control channel at timing 323 is omitted. With this, it is possible to reduce a processing load of monitoring the control channel by the terminal devices. In other words, it is possible to reduce overhead due to the control channel.

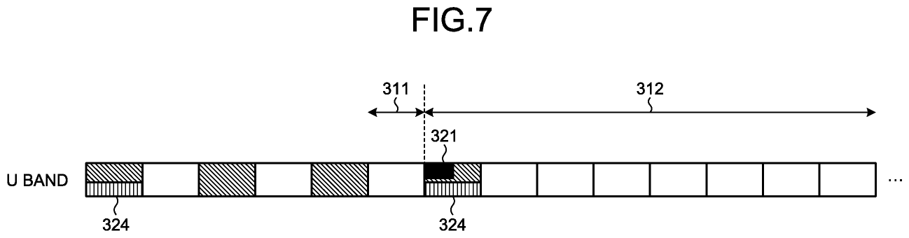

In FIG. 6, although the UL grant is transmitted by the control information 301 of the L band, the UL grant may be transmitted using the U band. FIG. 7 is a diagram illustrating an example in which a UL grant 324 is transmitted using the control channel of the U band. In FIG. 7, the same parts as those in FIGS. 5 and 6 are denoted by the same reference numerals. As illustrated in FIG. 7, for example, since the transmission timing of the UL grant 324 arrives at a 6-symbol cycle, but the transmission unit has the 2-symbol length, the timing, at which the signal of the control channel can be transmitted, arrives at the 2-symbol cycle. As described above, the transmission timing of the UL grant 324 and the transmission timing of the signal of the control channel do not have to always match each other.

As described above, according to the present embodiment, the base station device notifies terminal devices of the common transmission type, and transmits the common control information when starting communication with any terminal device by using the U band. Furthermore, another terminal device, other than the terminal device performing communication by using the U band, omits monitoring of the control channel for each transmission unit while the U band is occupied, based on the common control information. Therefore, it is possible to reduce a processing load of monitoring the control channel by the terminal devices and to reduce overhead due to the control channel.

### [c] Third Embodiment

The feature of a third embodiment is that a transmission type is notified by a control channel transmitted by a head symbol of a transmission unit.

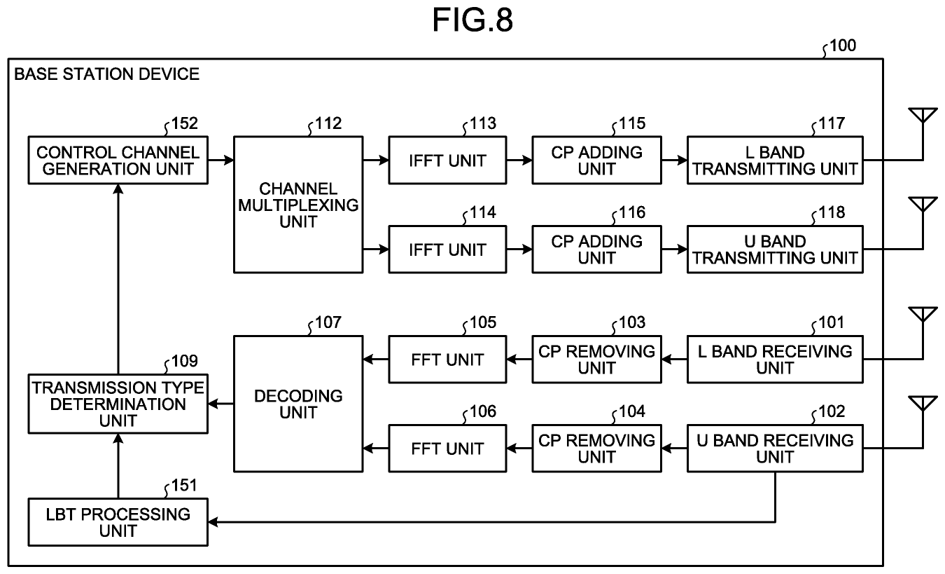

FIG. 8 is a block diagram illustrating a configuration of the base station device 100 according to the third embodiment. In FIG. 8, the same parts as those in FIG. 1 are denoted by the same reference numerals and a description thereof will be omitted. The base station device 100 illustrated in FIG. 8 has a configuration in which the notification information generation unit 110 of the base station device 100 illustrated in FIG. 1 is deleted and the LBT processing unit 108 and the control channel generation unit 111 are changed to an LBT processing unit 151 and a control channel generation unit 152.

The LBT processing unit 151 detects reception energy in the frequency band of the U band when transmission data to be transmitted to a terminal device using the U band has been generated, and determines whether the U band is available. That is, when data to be transmitted using the U band has been generated, the LBT processing unit 151 performs the LBT process such as carrier sense. However, even when transmission data has been generated, the LBT processing unit 151 performs the LBT process at a limited timing. Specifically, when a period in which the LBT process is possible is set at a predetermined cycle, the LBT processing unit 151 performs the LBT process within the set period.

The control channel generation unit 152 generates signals of the control channels of the L band and the U band. Specifically, for the U band, the control channel generation unit 152 generates the signal of the control channel arranged in the head symbol of the mini-slot in accordance with a transmission type. The control channel includes notification information for notifying terminal devices of the transmission type determined by the transmission type determination unit 109, in addition to allocation information of data arranged in the mini-slot. That is, the control channel generation unit 152 generates the signal of the control channel for notifying the transmission type when the time length of the transmission unit is changed for the U band.

In the third embodiment, since the period in which the LBT process is possible is set, the symbol of the U band immediately after the period is a symbol in which the control channel can be arranged. When the control channel is arranged in the symbol, the notification information for notifying the transmission type is included in the control channel. The terminal devices can receive the control channel and recognize the transmission type by monitoring the symbol of the U band immediately after the period in which the LBT process is possible. Thereafter, the terminal devices can monitor the presence or absence of the control channel for each transmission unit corresponding to the transmission type, and receive and decode data for each transmission unit.

Furthermore, when the transmission type is changed after the transmission type is notified once, it is sufficient if the base station device transmits the control channel including notification information again. After the transmission type is notified, since each terminal device monitors the presence or absence of the control channel for each transmission unit corresponding to the transmission type, each terminal device can receive the notification information included in the control channel and recognize a change in the transmission type.

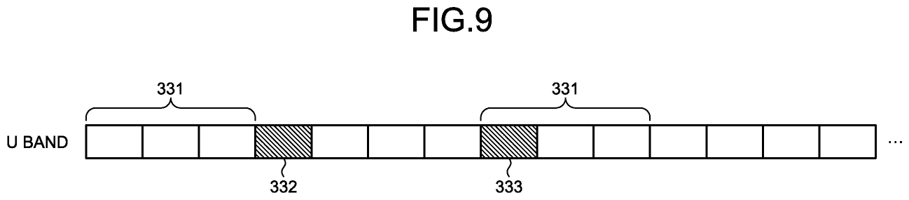

FIG. 9 is a diagram illustrating a specific example of downlink communication according to the third embodiment. FIG. 9 illustrates communication for each symbol length in the U band. As illustrated in FIG. 9, in the third embodiment, a period 331 in which the LBT process is possible periodically arrives. When data to be transmitted has been generated, the base station device performs the LBT process in the period 331. Then, when the base station device has performed the LBT process, the base station device arranges the control channel including the notification information in a symbol 332 immediately after the period 331 and transmits the control channel.

Since a terminal device monitors the symbol 332 immediately after the period 331 in order to confirm the presence or absence of the control channel, the terminal device receives the signal of the control channel transmitted in the symbol 332. Then, the terminal device specifies a transmission type from the notification information included in the control channel, and monitors the presence or absence of the control channel for each transmission unit according to the transmission type. In the example illustrated in FIG. 9, since the transmission type, in which the transmission unit has the 4-symbol length, is specified, the terminal device monitors a symbol 333 in order to confirm the presence or absence of the control channel.

As described above, when it is determined that a first control channel is arranged in the symbol 332 immediately after the period 331, since the transmission type is designated by the notification information included in the control channel, the terminal device then monitors the presence or absence of the control channel for each transmission unit according to the transmission type. Therefore, a change in the transmission type can be notified by the control channel, and the notification of the transmission type by a signal in an upper layer, such as RRC signaling, can be made unnecessary.

As described above, according to the present embodiment, the base station device notifies the transmission type by the control channel for each transmission unit of the U band, so that the notification of the transmission type by the upper layer signal can be made unnecessary.

Note that in the aforementioned third embodiment, the LBT process does not have to be performed during the entire period 331. That is, for example, in FIG. 9, the period 331 corresponds to a time length of three symbols, but the LBT process may be performed in the period of one symbol or two symbols among the three symbols. In such a case, when data transmission becomes possible as a result of the LBT process, the control channel may be arranged in a symbol immediately after the LBT process is performed. Consequently, for example, when the LBT process is performed in the period of the first one symbol of the period 331 and data transmission becomes possible, the first control channel is arranged in the second symbol in the period 331. In such a case, the terminal device monitors the second and third symbols in the period 331 and the symbol 332, in which the control channel can be arranged, in order to confirm the presence or absence of the control channel.

Note that the configurations of the base station device 100 and the terminal device 200 in the aforementioned each embodiment are merely examples, and the base station device and the terminal device do not always have to be configured as illustrated in FIGS. 1, 3, and 8. Specifically, for example, the L band receiving unit 101, the U band receiving unit 102, the L band transmitting unit 117, and the U band transmitting unit 118 of the base station device 100 in FIGS. 1 and 8 may also be configured as one or a plurality of wireless units. Furthermore, the other processing units of the base station device 100 in FIGS. 1 and 8 may also be configured as one or a plurality of processors. Similarly, the L band receiving unit 201, the U band receiving unit 202, the L band transmitting unit 215, and the U band transmitting unit 216 of the terminal device 200 in FIG. 3 may also be configured as one or a plurality of wireless units, and the other processing units may also be configured as one or a plurality of processors. Here, as the processor, for example, a central processing unit (CPU), a microprocessing unit (MPU), an application specific integrated circuit (ASIC), a field programmable gate array (FPGA), a digital signal processor (DSP), and the like can be used.

According to an aspect of the base station device, the terminal device, the communication system, and the transmission method disclosed in the present application, there is an effect that it is possible to suppress a decrease in frequency utilization efficiency.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station device included in a communication system using a first frequency band that needs a license and a second frequency band that needs no license, the base station device comprising:
a processor that executes a process including
judging whether the second frequency band is used by another communication system, and
determining a transmission type indicating a time length of a transmission unit in the second frequency band based on a judgment result at the judging; and
a transmitter that transmits notification information that notifies the transmission type determined at the determining.

2. The base station device according to claim 1, wherein
the process further includes generating a signal of a control channel related to the second frequency band, and
when the second frequency band is judged to be not used by the other communication system at the judging, the transmitter arranges the signal of the control channel generated at the generating, at a head of the transmission unit in the second frequency band, and transmits the signal of the control channel.

3. The base station device according to claim 2, wherein the generating includes generating the signal of the control channel including allocation information of data in the transmission unit in the second frequency band.

4. The base station device according to claim 2, wherein, when the second frequency band is used for data transmission addressed to one terminal device, the generating includes generating the signal of the control channel including common control information that indicates a time period during which the data transmission addressed to the one terminal device continues and that is addressed to another terminal device other than the one terminal device.

5. The base station device according to claim 2, wherein the generating includes generating the signal of the control channel including permission information that permits a terminal device to transmit data by using the second frequency band.

6. The base station device according to claim 2, wherein the generating includes generating the signal of the control channel including the notification information that notifies the transmission type determined at the determining.

7. A terminal device included in a communication system using a first frequency band that needs a license and a second frequency band that needs no license, the terminal device comprising:
a receiver that receives notification information that notifies a transmission type indicating a time length of a transmission unit in the second frequency band; and
a processor that executes a process including
specifying the transmission type from the notification information received by the receiver,
monitoring presence or absence of a signal of a control channel for each transmission unit corresponding to the transmission type, and
decoding data addressed to the terminal device from a transmission unit with the signal of the control channel.

8. The terminal device according to claim 7, wherein, when the signal of the control channel includes common control information that indicates a time period during which data transmission addressed to another terminal device different from the terminal device continues, the monitoring includes omitting monitoring of the presence or absence of the signal of the control channel during the time period indicated by the common control information.

9. A communication system including a base station device and a terminal device that perform wireless communication by using a first frequency band that needs a license and a second frequency band that needs no license, wherein
the base station device comprises:
a first processor that executes a process including
judging whether the second frequency band is used by another communication system, and
determining a transmission type indicating a time length of a transmission unit in the second frequency band based on a judgment result at the judging; and
a transmitter that transmits notification information that notifies the transmission type determined at the determining, and
the terminal device comprises:
a receiver that receives the notification information; and
a second processor that executes a process including
specifying the transmission type from the notification information received by the receiver,
monitoring presence or absence of a signal of a control channel for each transmission unit corresponding to the transmission type, and
decoding data addressed to the terminal device from a transmission unit with the signal of the control channel.

10. A communication method in a communication system using a first frequency band that needs a license and a second frequency band that needs no license, the communication method comprising:
judging whether the second frequency band is used by another communication system;
determining a transmission type indicating a time length of a transmission unit in the second frequency band based on a judgment result at the judging; and
transmitting notification information that notifies the determined transmission type.
